(19) United States
(12) Patent Application Publication
(10) Pub. No.: US 2025/0021066 A1
(43) Pub. Date: Jan. 16, 2025

(54) INFORMATION PROCESSING DEVICE, CONTROL SYSTEM, INFORMATION PROCESSING METHOD, AND RECORDING MEDIUM

(71) Applicant: Mitsubishi Electric Corporation, Tokyo (JP)

(72) Inventors: Junpei MASUHO, Nagoya-shi, Aichi (JP); Mikio TAKADA, Tokyo (JP)

(73) Assignee: Mitsubishi Electric Corporation, Tokyo (JP)

(21) Appl. No.: 18/711,880

(22) PCT Filed: Apr. 28, 2022
(86) PCT No.: PCT/JP2022/019444

§ 371 Date: May 21, 2024

(51) Int. Cl. G05B 15/02; G06V 10/70; G06V 20/50

(52) U.S. Cl. CPC G05B 15/02; G06V 10/70; G06V 20/50

(57) ABSTRACT

An information processing device includes an application controller, an image analyzer, and a communication controller. The application controller executes an application that causes an image to be displayed on a display. The image analyzer analyzes the image displayed on the display by the application. The communication controller converts, based on a result of analysis of the image by the image analyzer, data obtained from the image displayed on the display by the application into data recognizable by a control machine, and transmits the converted data to the control machine.

### TECHNICAL FIELD

The present disclosure relates to an information processing device, a control system, an information processing method, and a program.

### BACKGROUND ART

Some manufacturing factories employ information devices, including tablets, for managing the presence and absence of operators, and control machines including programmable logic controllers (PLCs) for operating facilities. Each of these information devices manages the presence and absence of operators using a general-purpose application, and causes a display to display data indicating the presence of an operator in response to the entrance of the operator into a room. In addition, an operator who has entered the room manipulates the control machine to activate the facilities. This manipulating task by the operator can be eliminated if the general-purpose application can transmit data indicating the presence of the operator to the control machine and automatically activate the facilities, leading to higher operational efficiency.

However, to coordinate the information device with the control machine, using a dedicated application having a function of coordination with the control machine is required. Due to this, the configuration of coordinating the information device with the control machine has a problem of causing a significant increase in development costs.

Patent Literature 1 discloses a technique for generating a dedicated application that can coordinate an information device with an external device. The technique introduces a command conversion library for mutual conversion between a control command in the format recognizable by the dedicated application and a control command in the format recognizable by the external device.

### CITATION LIST

### Patent Literature

Patent Literature 1: Unexamined Japanese Patent Application Publication No. 2015-162214

### SUMMARY OF INVENTION

### Technical Problem

In an exemplary case where the format of the control command recognizable by the external device is unknown, the technique disclosed in Patent Literature 1, which introduces the command conversion library to coordinate the information device with the external device, cannot readily generate a dedicated application. In another exemplary case where the technique tries to coordinate the information device with a control machine including a factory automation (FA) device, the specification of the communication protocol or interface must be released, to allow third parties to generate a dedicated application for coordination with the control machine.

The present disclosure is made in view of the above situations, and an objective of the present disclosure is to provide an information processing device, a control system, an information processing method, and a program that can coordinate a control machine and an application incompatible with the control machine.

### Solution to Problem

In order to achieve the above objective, an information processing device according to the present disclosure includes: an application controller to control an application that causes an image to be displayed on a display; an image analyzer to analyze the image displayed on the display by the application; and a communication controller to convert, based on a result of analysis of the image by the image analyzer, data obtained from the image displayed on the display by the application into data recognizable by a control machine, and transmit the converted data to the control machine.

### Advantageous Effects of Invention

The information processing device according to the present disclosure converts data obtained from the image displayed on the display by the application into data recognizable by a control machine, and transmits the converted data to the control machine. The information processing device can thus coordinate the control machine and the application incompatible with the control machine.

### BRIEF DESCRIPTION OF DRAWINGS

FIG. 1 illustrates a control system according to an embodiment;

FIG. 2 illustrates an information processing device according to the embodiment;

FIG. 3 is a block diagram illustrating an information processing device according to the embodiment;

FIG. 4A illustrates a screen of a display of the information processing device according to the embodiment;

FIG. 4B illustrates a first table according to the embodiment;

FIG. 4C illustrates a second table according to the embodiment;

FIG. 5 illustrates a control machine according to the embodiment;

FIG. 6 is a block diagram illustrating a control machine according to the embodiment;

FIG. 7 is a flowchart illustrating a setting process according to the embodiment;

FIG. 8 is a diagram for describing the setting process according to the embodiment;

FIG. 9 is another diagram for describing the setting process according to the embodiment;

FIG. 10 is a flowchart illustrating a control process according to the embodiment; and

FIG. 11 is a diagram for describing the control process according to the embodiment.

### DESCRIPTION OF EMBODIMENTS

The following describes an information processing device and a control system according to an embodiment of the present disclosure, with reference to the accompanying drawings.

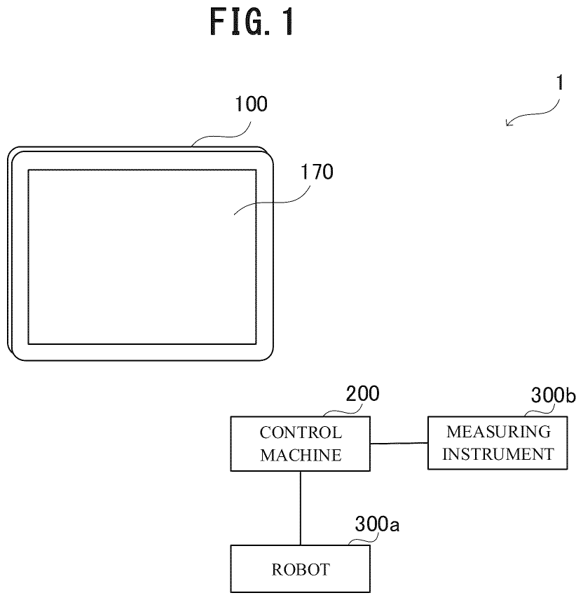

A control system 1 according to the embodiment is a system for coordinating application software (hereinafter referred to as “application”) for labor management involving management of presence and absence of operators with a control machine. As illustrated in FIG. 1, the control system 1 includes an information processing device 100 having a display 170, and a control machine 200 that communicates with the information processing device 100 and controls a robot 300a. The control system 1 having this configuration automatically turns on the robot 300a in response to the entrance of a user into a room, and automatically turns off the robot 300a in response to the exit of the operator, for example.

The control machine 200 is connected to the robot 300a and a measuring instrument 300b. The control system 1 controls the robot 300a, and can eliminate tasks of manually inputting measured data obtained from the measuring instrument 300b into a factory automation (FA) system, or tasks of manually inputting data output from the control machine 200 into a general-purpose application. The information processing device 100 is connected to the control machine 200 by wired communication using a universal serial bus (USB) cable, or wireless communication using Wi-Fi (registered trademark).

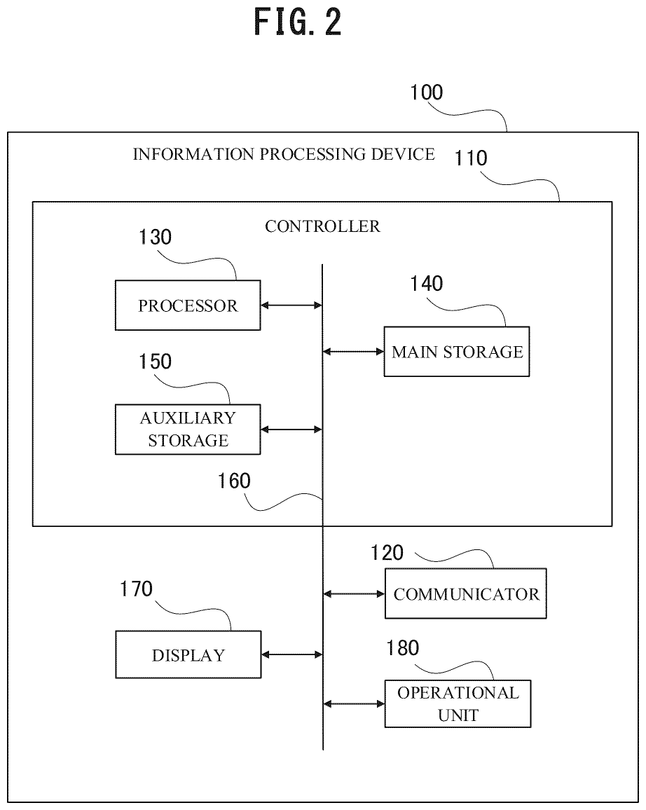

The information processing device 100 includes a smartphone or a tablet personal computer (PC). As illustrated in FIG. 2, the information processing device 100 includes a controller 110 that executes a program, a communicator 120 that communicates with the control machine 200, a display 170 that displays an image, and an operational unit 180 that receives a manipulation of a user.

The controller 110 includes a processor 130 that executes processes for controlling the communicator 120, the display 170, and the operational unit 180, a main storage 140 that serves as a work area of the processor 130, and an auxiliary storage 150 that stores various types of data and programs to be used in the processes of the processor 130. The main storage 140 and the auxiliary storage 150 are each connected to the processor 130 via buses 160.

The processor 130 includes a micro processing unit (MPU). The processor 130 executes a program stored in the auxiliary storage 150 and thereby performs various functions of the information processing device 100.

The main storage 140 includes a random access memory (RAM). The main storage 140 receives the program loaded from the auxiliary storage 150. The main storage 140 serves as a work area of the processor 130, and stores data to be transmitted to the control machine 200.

The auxiliary storage 150 includes a non-volatile memory, such as an electrically erasable programmable read-only memory (EEPROM). The auxiliary storage 150 stores the program, general-purpose application, and various types of data to be used in the processes of the processor 130. The auxiliary storage 150 provides the processor 130 with data to be used by the processor 130 and stores data fed from the processor 130, under the instructions from the processor 130.

The communicator 120 transmits signals indicating data output from the processor 130, to the control machine 200. The communicator 120 also receives signals from the control machine 200, and outputs data indicated by the received signals to the processor 130.

The display 170 displays an image necessary for manipulations. The display 170 includes a liquid crystal display (LCD) or an organic electroluminescence (EL) display.

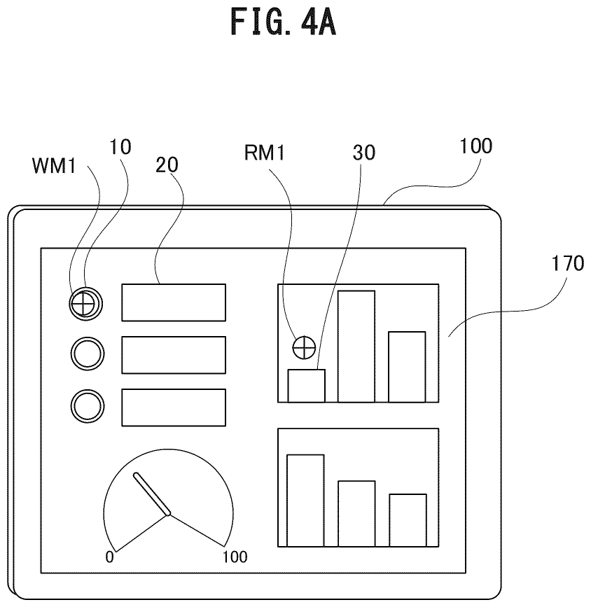

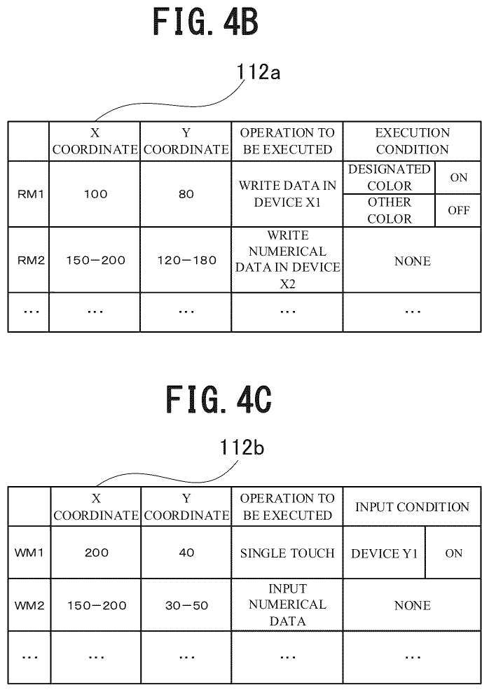

The operational unit 180 includes a graphical user interface (GUI), and receives an instruction on the basis of a manipulation input from the user. The operational unit 180 and the display 170 constitute a touch panel display. For example, as illustrated in FIG. 4A, when the user touches with a finger any of touch points 10 displayed on the display 170 by the general-purpose application, the operational unit 180 inputs data indicating reception of a touching manipulation into the general-purpose application. When the user enters characters or numerals into any of entry boxes 20 displayed on the display 170 by the general-purpose application, the operational unit 180 inputs data indicating the entered characters or numerals into the general-purpose application.

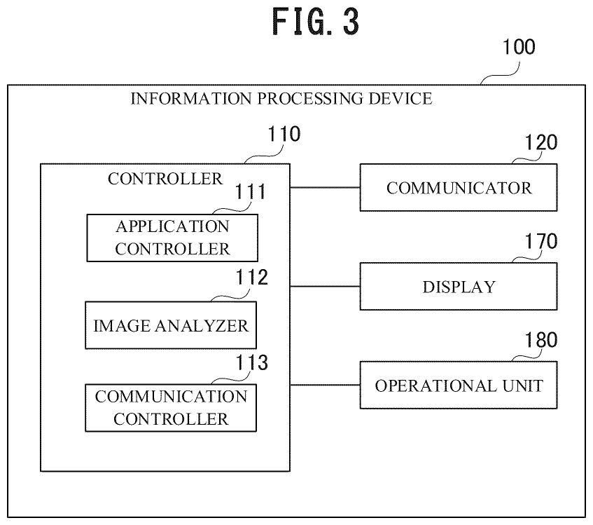

The controller 110 executes the program stored in the auxiliary storage 150, and thus functions as an application controller 111 that executes an application, an image analyzer 112 that analyzes the image displayed by the application, and a communication controller 113 that controls communication with the control machine 200, as illustrated in FIG. 3.

The application controller 111 executes the general-purpose application stored in the auxiliary storage 150. The general-purpose application is incompatible with the control machine 200, and includes an existing application. For example, the general-purpose application includes an application for labor management involving management of the presence and absence of operators. This application causes the display 170 to display an image, as illustrated in FIG. 4A. This image contains bar graphs 30 representing whether operators are present in the room. In the example illustrated in FIG. 4A, a short bar graph 30 represents the “absence” of the operator, and a long bar graph 30 represents the “presence” of the operator. The bar graphs 30 do not necessarily directly represent the presence or absence of operators, and may represent any data varying depending on the presence or absence. The application controller 111 may be achieved by the operating system (OS) of the information processing device 100. The application controller 111 also activates the general-purpose application stored in the auxiliary storage 150, on the basis of the data transmitted from the control machine 200.

The image analyzer 112 analyzes the image displayed by the general-purpose application, and extracts, from the image displayed at a predetermined position in the display area of the display 170, data to be transmitted to the control machine 200. The image analyzer 112 also specifies one data entry area disposed at a predetermined position among multiple data entry areas displayed by the general-purpose application, superimposes the data received from the control machine 200 on the specified data entry area, and inputs the data into the application through a predetermined inputting operation. For example, the image analyzer 112 sets a reading marker RM1 at the position designated by the user in the display 170. The image analyzer 112 then sets the position coordinates of the reading marker RM1, the operation to be executed by a device included in the control machine 200, and the execution condition for determination of whether to execute the operation. The image analyzer 112 then records the set pieces of data into a first table 112a illustrated in FIG. 4B. The first table 112a is stored in the auxiliary storage 150. In the case where the position of the marker RM1 is the position as illustrated in FIG. 4A, in the case of a long bar graph 30, the color at the position is a designated color that is the color of the bar graph 30, and in contrast, in the case of a short bar graph 30, the color at the position is a color other than the designated color. The image analyzer 112 identifies the color at the position at which the reading marker RM1 is set and thus acquires data for determination of whether the operator is present in the room. In addition, the image analyzer 112 sets a writing marker WM1 at the position designated by the user in the image displayed by the general-purpose application. The image analyzer 112 then sets the position coordinates of the writing marker WM1, the data transmitted from a device included in the control machine 200, and the input condition for determination of whether to input the transmitted data into the general-purpose application. The image analyzer 112 then records the set pieces of data into a second table 112b illustrated in FIG. 4C. The writing marker WM1 is set in an area that can receive a manipulation of the user for inputting data into the general-purpose application, in the display 170 on which the image is displayed by the general-purpose application. The second table 112b is stored in the auxiliary storage 150. The image analyzer 112 also reads the data indicated at the position at which the reading marker RM1 is set. In detail, the image analyzer 112 reads the color at the position at which the reading marker RM1 is set. The image analyzer 112 also executes an operation for entering the data transmitted from the control machine 200 into the data entry area at the position at which the writing marker WM1 is set, to input the data into the application. In detail, on the basis of the data transmitted from the control machine 200, the image analyzer 112 executes, with the program, an operation equivalent to single touching, double touching, pulling down, or entering numerals or characters into an entry box, at the position at which the writing marker WM1 is set, to input the data into the general-purpose application.

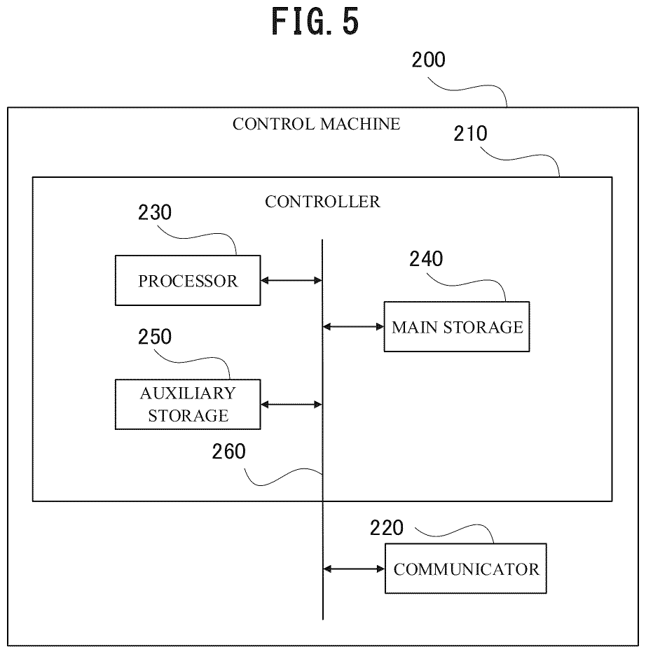

The communication controller 113 controls the communicator 120 and thus communicates with the control machine 200. The communication controller 113 converts the data obtained from the image displayed on the display 170 by the general-purpose application into data recognizable by the control machine 200, and transmits the converted data to the control machine 200. For example, the communication controller 113 converts the data indicated at the position at which the reading marker RM1 is set into data recognizable by the control machine 200, and transmits the converted data to the control machine 200. This data contains setting indicating the device included in the control machine 200, the operation to be executed by the control machine 200, and the execution condition of the operation that are set in association with the position at which the reading marker RM1 is set as described above. The communication controller 113 also receives data transmitted from the control machine 200 via the communicator 120. The control machine 200 includes a programmable logic controller (PLC). The control machine 200 is connected to the information processing device 100 such that the control machine 200 is capable of wired or wireless communication with the information processing device 100. The control machine 200 receives data transmitted from the information processing device 100, and transmits data to the information processing device 100. The control machine 200 is connected to the robot 300a and the measuring instrument 300b. The robot 300a is controlled in accordance with the data transmitted from the control machine 200. The measuring instrument 300b transmits measured data to the control machine 200. As illustrated in FIG. 5, the control machine 200 includes a controller 210 and a communicator 220.

The controller 210 includes a processor 230 that executes processes for controlling the robot 300a, a main storage 240 that serves as a work area of the processor 230, and an auxiliary storage 250 that stores various types of data and programs to be used in the processes of the processor 230. The main storage 240 and the auxiliary storage 250 are each connected to the processor 230 via buses 260.

The processor 230 includes an MPU. The processor 230 executes a program stored in the auxiliary storage 250 and thereby performs various functions of the control machine 200.

The main storage 240 includes a RAM. The main storage 240 receives the program loaded from the auxiliary storage 250. The main storage 240 serves as a work area of the processor 230.

The auxiliary storage 250 includes a non-volatile memory, such as EEPROM. The auxiliary storage 250 stores the program and various types of data to be used in the processes of the processor 230. The auxiliary storage 250 provides the processor 230 with data to be used by the processor 230 and stores data fed from the processor 230, under the instructions from the processor 230.

The communicator 220 includes a network interface circuit for communication with the information processing device 100. The communicator 220 receives signals from the information processing device 100 and the measuring instrument 300b, and outputs data indicated by the received signals to the processor 230. The communicator 220 also transmits signals indicating data output from the processor 230, to the robot 300a or an external device.

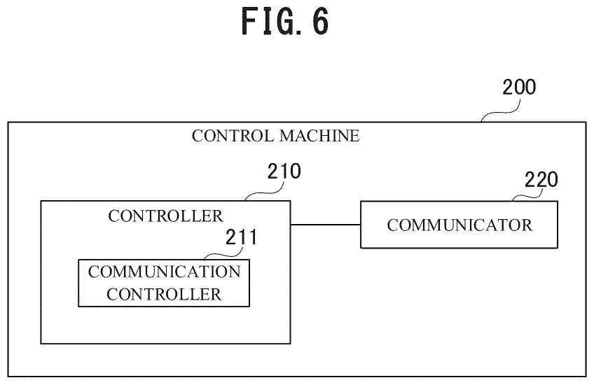

The controller 210 executes the program stored in the auxiliary storage 250 and thus functions as a communication controller 211, as illustrated in FIG. 6.

The communication controller 211 communicates with the information processing device 100 via the communicator 220. The communication controller 211 also controls the robot 300a, on the basis of the data transmitted from the information processing device 100. The communication controller 211 also transmits the data received from the measuring instrument 300b to the information processing device 100.

A setting process and a control process executed by information processing device 100 having the above-described configuration are described below. The setting process is a process for establishing the setting for coordinating the general-purpose application with the control machine 200. The control process is a process for transmitting data from the general-purpose application to the control machine 200 and controlling the robot 300a on the basis of the transmitted data. The control process also involves inputting the data measured by the measuring instrument 300b and transmitted from the control machine 200 into the general-purpose application.

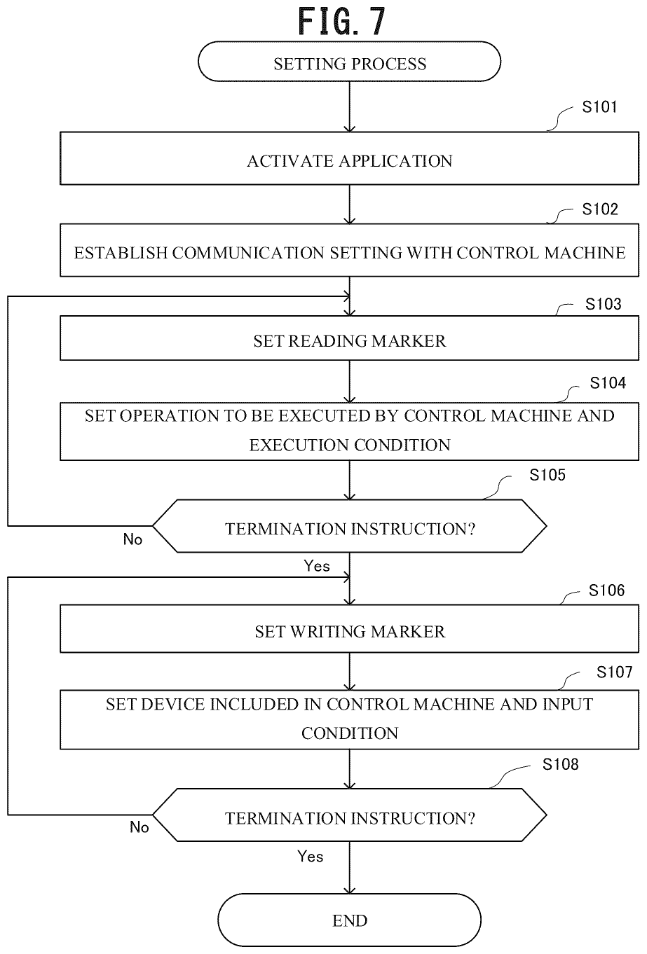

In response to an instruction to initiate the process from the user, the information processing device 100 initiates the setting process illustrated in FIG. 7. The user also activates the control machine 200. The setting process executed by the information processing device 100 is described below with reference to the flowchart.

At the start of the setting process, the application controller 111 activates the general-purpose application stored in the auxiliary storage 150 (Step S101). Upon the activation of the general-purpose application, the image illustrated in FIG. 4A is displayed on the display 170.

The communication controller 113 establishes the communication setting with the control machine 200 in accordance with manipulations of the user (Step S102).

The user then designates, as the position of the reading marker RM1, the position that enables discriminating a long bar graph 30 from a short bar graph 30, so as to determine whether the operator is present in the room on the basis of the bar graph 30 illustrated in FIG. 4A. The image analyzer 112 thus sets the position of the reading marker RM1 in the display 170 on which the image is displayed by the general-purpose application (Step S103), and records the position coordinates of the reading marker RM1 into the first table 112a illustrated in FIG. 4B.

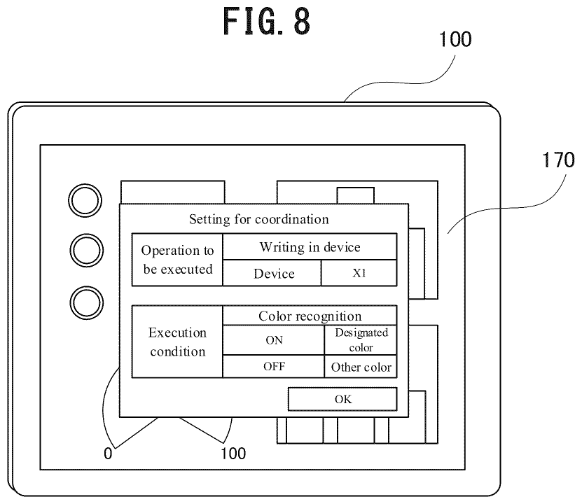

The image analyzer 112 sets a device X1 included in the control machine 200, the operation to be executed by the device X1, and the execution condition for determination of whether to execute the operation, in association with the reading marker RM1, as illustrated in FIG. 8, in accordance with input from the user (Step S104), and records the set pieces of data into the first table 112a illustrated in FIG. 4B. The operation to be executed by the device X1 is turning on or off the main power switch of the robot 300a on the basis of the transmitted data. The execution condition depends on whether the color at the position at which the reading marker RM1 is set is the designated color or other color. In the case of the designated color, the data indicating ON is transmitted. In the case of a color other than the designated color, the data indicating OFF is transmitted.

The image analyzer 112 then determines whether an instruction to terminate the setting of reading markers is input (Step S105). When determining that no termination instruction is input (Step S105; No), the image analyzer 112 returns to Step S103 and repeats Steps S103 to S105. The repetition of the steps can set multiple reading markers.

When determining that a termination instruction is input (Step S105; Yes), the image analyzer 112 guides the user to designate, as the position of the writing marker, any of the data entry areas in the displayed image. The image analyzer 112 sets the writing marker WM1 at the position designated by the user, in the display area of the display 170 on which the image illustrated in FIG. 4A is displayed by the general-purpose application (Step S106).

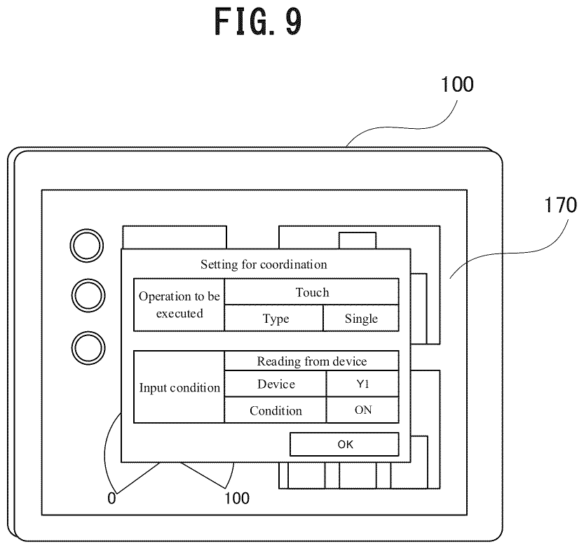

The image analyzer 112 sets a device Y1 included in the control machine 200, the inputting operation, and the input condition for determination of whether to input data, in association with the writing marker WM1, as illustrated in FIG. 9, in accordance with input from the user (Step S107), and records the set pieces of data into the second table 112b illustrated in FIG. 4C. This step associates the writing marker WM1 with the device Y1. The inputting operation in this example indicates an operation of inputting data into the general-purpose application by single touching. The image analyzer 112 executes, with the program, an operation equivalent to single touching by a user, to input the data into the general-purpose application.

The image analyzer 112 then determines whether an instruction to terminate the setting of writing markers is input (Step S108). When determining that no termination instruction is input (Step S108; No), the image analyzer 112 returns to Step S106 and repeats Steps S106 to S108. The repetition of these steps can set multiple writing markers.

When it is determined that a termination instruction is input (Step S108; Yes), the setting process is terminated. The control process also involves inputting the data measured by the measuring instrument 300b and transmitted from the control machine 200 into the general-purpose application.

The completion of the above-described setting process allows for transmission of data from the general-purpose application to the control machine 200, and control of the robot 300a on the basis of the transmitted data. The following description is focused on the control process of controlling the robot 300a.

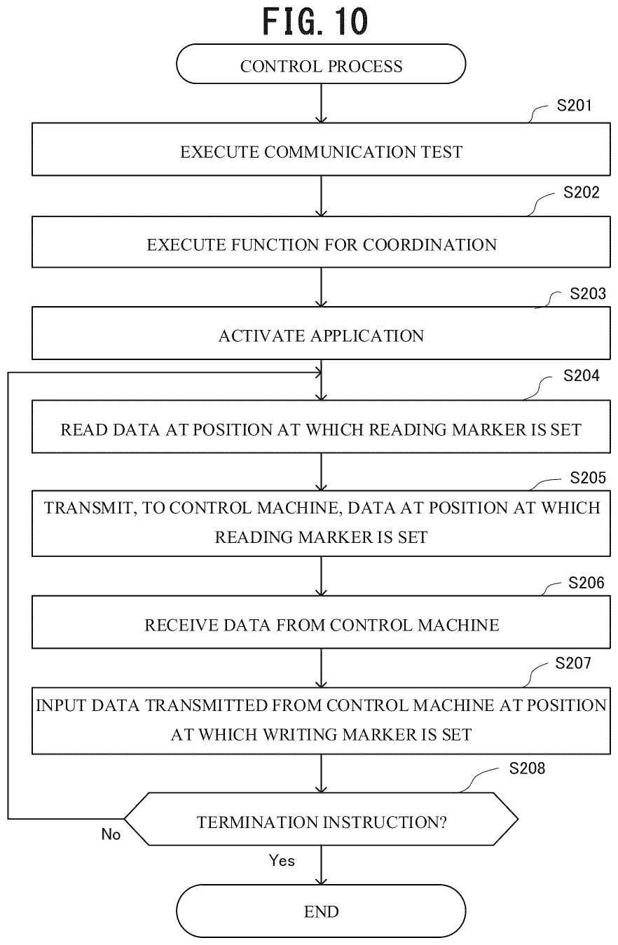

In response to an instruction to initiate the process from the user, the information processing device 100 initiates the control process illustrated in FIG. 10.

At the start of the control process, the communication controller 113 executes a communication test with the control machine 200 (Step S201). The user executes a program for coordination with the control machine 200. The execution of the program for coordination with the control machine 200 is followed by transmission of a trigger signal from the control machine 200 to the information processing device 100. The communication controller 113 then establishes the communication setting with the control machine 200 (Step S202).

After establishment of the communication setting, the control machine 200 transmits the data for activating the general-purpose application. The application controller 111 then activates the general-purpose application stored in the auxiliary storage 150, on the basis of the data transmitted from the control machine 200 (Step S203).

The image analyzer 112 then reads the data indicated at the position at which the reading marker RM1 is set, in the image displayed on the display 170 illustrated in FIG. 4A by the general-purpose application, in order to determine whether the operator has entered the room (Step S204). Specifically, the image analyzer 112 refers to the first table 112a illustrated in FIG. 4B, and reads the data indicated at the position in the image at which the reading marker RM1 is set, on the basis of the position coordinates of the reading marker RM1 recorded in the first table 112a. The image analyzer 112 then detects the individual intensities of red, blue, and green components in the position at which the reading marker RM1 is set from a screenshot of the image displayed on the display 170, and determines whether being the designated color or other color.

The communication controller 113 then transmits the data indicated at the position at which the reading marker RM1 is set, which is read in the Step S204, to the control machine 200, in order to provide the data indicating whether the operator has entered the room (Step S205). This data is recorded in the first table 112a illustrated in FIG. 4B, and contains setting indicating the device X1 included in the control machine 200, the operation to be executed by the device X1 included in the control machine 200, and the execution condition of the operation that are set in association with the position at which the reading marker RM1 is set. That is, the communication controller 113 transmits the data indicating ON when the color at the position at which the reading marker RM1 is set is the designated color, or transmits the data indicating OFF when the color at the position is a color other than the designated color, to the device X1 included in the control machine 200. On the basis of the data indicating ON or data indicating OFF transmitted to the device X1, the control machine 200 controls the robot 300a.

The communication controller 113 then receives data transmitted from a device included in the control machine 200, via the communicator 120 (Step S206).

The image analyzer 112 then refers to the data recorded in the second table 112b illustrated in FIG. 4C, on the basis of the data transmitted from the device Y1 and containing the identification (ID) of the device Y1, and finds that the data transmitted from the device Y1 is associated with the coordinates of the position at which the writing marker WM1 is set. The image analyzer 112 thus executes an inputting operation of inputting the data transmitted from the device Y1 included in control machine 200, at the coordinates of the position at which the writing marker WM1 is set, to input the data into the general-purpose application (Step S207). In accordance with the setting established in Step S107 in FIG. 7, the inputting operation is an operation for inputting data into the general-purpose application by single touching in the case of the data indicating ON transmitted from the device Y1, and the inputting operation is not executed in the case of the data indicating OFF transmitted from the device Y1. The image analyzer 112 executes an operation, with the program, equivalent to a user's touching manipulation on the display 170.

The image analyzer 112 then determines whether a termination instruction is input (Step S208). When determining that no termination instruction is input (Step S208; No), the image analyzer 112 returns to Step S204 and repeats Steps S204 to S208. When determining that a termination instruction is input (Step S208; Yes), the image analyzer 112 terminates the control process.

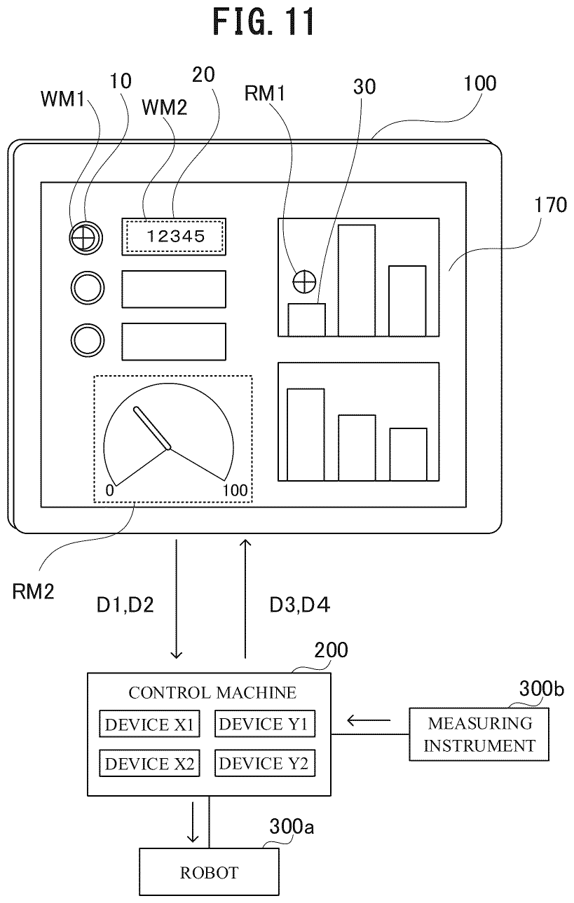

The setting process and receiving process executed by the information processing device 100 are described below, focusing on an example that involves setting of reading markers RM1 and RM2 and writing markers WM1 and WM2 in the display area of the display 170 on which an image is displayed by the general-purpose application for labor management involving management of the presence and absence of operators, and involves controlling the control machine 200, as illustrated in FIG. 11.

In response to an instruction to initiate the process from the user, the information processing device 100 initiates the setting process illustrated in FIG. 7. The user also activates the control machine 200.

At the start of the setting process, the application controller 111 activates the general-purpose application stored in the auxiliary storage 150 (Step S101; FIG. 7). Upon the activation, an image is displayed on the display 170 by the general-purpose application. This image contains the touch points 10 that allow the user to input data into the general-purpose application by a touching manipulation with a finger, the entry boxes 20 for entry of characters or numerals, and the bar graphs 30 representing whether the operators are present in the room.

The image analyzer 112 then sets the reading marker RM1 at the position designated by the user in the display area of the display 170 on which the image is displayed by the general-purpose application (Step S103; FIG. 7). The reading marker RM1 in this example is set at the position that enables determining whether an operator is present in the room on the basis of the length of one of the bar graphs 30.

The image analyzer 112 sets the device X1 included in the control machine 200, the operation to be executed by the device X1 included in the control machine 200, and the execution condition for determination of whether to execute the operation, in association with the position at which the reading marker RM1 is set (Step S104; FIG. 7). The operation to be executed by the device X1 is turning on or off the main power switch of the robot 300a. The execution condition depends on whether the color at the position at which the reading marker RM1 is set is the designated color or other color. When the color at the position at which the reading marker is set RM1 is the designated color because of the long bar graph 30, the image analyzer 112 determines that the operator has entered the room, followed by transmission of the data indicating ON. When the color at the position is a color other than the designated color, the data indicating OFF is transmitted. This data is recorded into the first table 112a.

When determining that no termination instruction is input (Step S105; No; FIG. 7), the image analyzer 112 sets the reading marker RM2 at the position designated by the user, in the display area of the display 170 on which the image is displayed by the general-purpose application (Step S103; FIG. 7). The reading marker RM2 in this example is set in the area representing an indicator for the cleanliness of air, in the display area of the display 170.

The image analyzer 112 then sets the device X2 included in the control machine 200, the operation to be executed by the device X2 included in the control machine 200, and the execution condition for determination of whether to execute the operation, in association with the position at which the reading marker RM2 is set (Step S104; FIG. 7). The operation to be executed is analyzing the image in the area in which the reading marker RM2 is set, converting the image into a value, and transmitting data D2 indicating the converted value to the device X2. No condition is required for execution of the operation. The data D2 indicates a power output from the motor of the fan of an air purifier included in the robot 300a.

When determining that a termination instruction is input (Step S105; Yes; FIG. 7), the image analyzer 112 sets the writing marker WM1 at the position designated by the user, in the display area of the display 170 on which the image is displayed by the general-purpose application (Step S106; FIG. 7).

The image analyzer 112 then sets the data transmitted from the control machine 200 and the input condition for determination of whether to input data into the general-purpose application, in association with the position at which the writing marker WM1 is set (Step S107; FIG. 7). The data transmitted from the control machine 200 is data D3 transmitted from the device Y1 included in the control machine 200. The inputting operation is single touching. The input condition is satisfied when the data D3 indicates ON.

When determining that no termination instruction is input (Step S108; No; FIG. 7), the image analyzer 112 sets the writing marker WM2 at the position designated by the user, in the display area of the display 170 on which the image is displayed by the general-purpose application (Step S106; FIG. 7). The writing marker WM2 is set in the area containing one of the entry boxes for entry of values in the display area of the display 170.

The image analyzer 112 sets the data transmitted from the control machine 200 and the input condition of the data, in association with the position at which the writing marker WM2 is set (Step S107; FIG. 7). The data transmitted from the control machine 200 is data D4 transmitted from the device Y2 included in the control machine 200. The inputting operation is an operation for inputting the value indicated by the data D4. No input condition is required.

When it is determined that a termination instruction is input (Step S108; Yes; FIG. 7), the setting process is terminated.

In the case where the user causes the information processing device 100 to control the control machine 200 after completion of the setting process, the user performs a manipulation of initiating the control process illustrated in FIG. 10 on the information processing device 100. The user also activates the control machine 200.

At the start of the control process, the communication controller 113 executes a communication test with the control machine 200 (Step S201; FIG. 10). The communication controller 113 then executes the function of coordination with the control machine 200, in response to a user's manipulation of executing the program for coordination with the control machine 200 (Step S202; FIG. 10). The execution of the function of coordination is followed by transmission of the data for activating the general-purpose application from the control machine 200. On the basis of the data transmitted from the control machine 200, the application controller 111 activates the general-purpose application stored in the auxiliary storage 150 (Step S203; FIG. 10).

The image analyzer 112 then reads the data indicated at the positions at which the reading markers RM1 and RM2 are set, in the image displayed on the display 170 illustrated in FIG. 11 by the general-purpose application (Step S204; FIG. 10). When the color at the position at which the reading marker RM1 is set is the designated color, the image analyzer 112 obtains data D1 indicating ON. When the color at the position is a color other than the designated color, the image analyzer 112 obtains data D1 indicating OFF. The image analyzer 112 also obtains data D2 by analyzing the image of the region in which the reading marker RM2 is set and converting the image into a value.

The communication controller 113 then transmits the data D1 and D2 indicated at the positions at which the reading markers RM1 and RM2 are set, which is read in Step S203, to the control machine 200 via the communicator 120 (Step S205; FIG. 10). The data D1, which indicates ON when the color at the position at which the reading marker RM1 is set is a designated color, and indicates OFF when the color at the position is other color, is transmitted to the device X1. The data D2, which indicates a value generated by analysis and conversion of the image of the position at which the reading marker RM2 is set, is transmitted to the device X2. After the transmission of the data D1 and D2 to the devices X1 and X2, the control machine 200 controls the robot 300a on the basis of the data D1 and D2 transmitted to the devices X1 and X2. For example, the data D1 is used to turn on or off the main power switch of the robot 300a, whereas the data D2 indicates a power output from the motor of the fan of the air purifier included in the robot 300a.

The communication controller 113 then receives data transmitted from the control machine 200 (Step S206; FIG. 10). The following describes an example in which the communication controller 113 receives the data D3 and D4 transmitted from the control machine 200. The data D3 and D4 is transmitted from the measuring instrument 300b to the devices Y1 and Y2 of the control machine 200 and stored in the devices Y1 and Y2, respectively. The devices Y1 and Y2 of the control machine 200 are associated in the second table 112b with the writing markers WM1 and WM2, respectively. For example, the data D3 indicates a temperature of the room for the operator measured by the measuring instrument 300b. In the case of a measured temperature equal to or higher than a reference temperature, the data D3 indicates ON. In the case of a measured temperature lower than the reference temperature, the data D3 indicates OFF. The data D4 is numerical data indicating the number of products fabricated by the operator.

The image analyzer 112 then executes an operation of entering the data D3 and D4 transmitted from the control machine 200 into the positions at which the writing markers WM1 and WM2 are set, respectively, to input the data D3 and D4 into the general-purpose application (Step S207; FIG. 10). The data D3 is transmitted from the device Y1. The second table 112b reveals that the inputting operation is an operation for inputting data into the general-purpose application by single touching, and the input condition is satisfied when the data D3 indicates ON. In the case of a measured temperature equal to or higher than the reference temperature, the data D3 indicates ON, and the data D3 is input into the general-purpose application by execution, with the program, an inputting operation of entering the data D3 into the position of the writing marker WM1 equivalent to a single touching, to input the data D3 into the general-purpose application. The data D4 from the control machine 200 is transmitted from the device Y2. The second table 112b reveals that the inputting operation is an operation for inputting the value indicated by the data D4, and no input condition is required. The data D4 is numerical data indicating the number of products fabricated by the operator, and is input into the general-purpose application by execution, with the program, an inputting operation of entering the data D4 into the position at which the writing marker WM2 is set, to input the data D4 into the general-purpose application. In the case of a temperature of a workplace for the operator equal to or higher than the reference temperature, the data indicating the temperature is input into the general-purpose application. The number of products fabricated by the operator is also input into the general-purpose application. These pieces of data contributes to labor management.

The image analyzer 112 then determines whether a termination instruction is input (Step S208; FIG. 10). When determining that no termination instruction is input (Step S208; No; FIG. 10), the image analyzer 112 returns to Step S204 and repeats Steps S204 to S208. When determining that a termination instruction is input (Step S208; Yes; FIG. 10), the image analyzer 112 terminates the control process.

The information processing device 100 having the above-described configuration can coordinate the general-purpose application with the control machine 200, on the basis of the data obtained from the image displayed on the display 170 by the general-purpose application. The information processing device 100 can thus readily coordinate various existing applications operating in the information processing device 100 with a control machine. The information processing device 100 can therefore eliminate the need for development of dedicated applications and functions for coordination of the individual applications and thus reduce the development costs. In addition, the information processing device 100 allows the user to determine the details of the coordination through manipulations on the information processing device 100, and thus enables even a user lacking expert knowledge of programing to build a coordination system. Although the information processing device 100 coordinates the general-purpose application for management of the presence and absence of operators with the control machine 200 in the above-described example, the information processing device 100 can coordinate any general-purpose application with the control machine 200. The coordinated general-purpose application can control the facilities including the control machine 200 coordinated with the application, leading to a wider variety of systems to be built. The coordination of the general-purpose application with the control machine 200 can achieve automatic manipulations of the general-purpose application, and can reduce the user's tasks of manually inputting data into the information processing device 100 and accompanying errors.

### Modified Example

The image analyzer 112 of the information processing device 100 may read data from the image displayed by the general-purpose application and input data into the general-purpose application, without setting the reading markers RM1 and RM2 and the writing markers WM1 and WM2. The image analyzer 112 in this case analyzes the image displayed on the display 170 by the general-purpose application using any one or combination of artificial intelligence, machine learning, and pattern recognition. The image analyzer 112 in this case extracts, from the image that is displayed on the display 170 and represents data on the item designated by the user, data to be transmitted to the control machine 200 using any one or combination of artificial intelligence, machine learning, and pattern recognition. For example, in order to determine whether an operator is present in the room, the image analyzer 112 executes machine learning using supervision data containing images displayed by the general-purpose application during the presence of the operator and images displayed by the general-purpose application during the absence of the operator, and generates a determination model for determining whether the operator is presence or absence from an image displayed by the general-purpose application. This determination model enables the image analyzer 112 to determine whether the operator is present in the room from an image displayed by the general-purpose application. Specifically, the image analyzer 112 obtains data on the image that is displayed on the display 170 by a screenshot function, for example, and analyzes the obtained image data. The image data may be analyzed by any of various procedures including color recognition based on the pixel values of the image or character recognition (optical character recognition; OCR), for example.

Although the image analyzer 112 of the information processing device 100 reads the image displayed by the general-purpose application and inputs data into the general-purpose application in the above-described exemplary embodiment, the image analyzer 112 may execute only either of the reading of the image displayed by the general-purpose application and the inputting of data into the general-purpose application. This configuration can be applied to both of the case of one-way transmission of data from the general-purpose application to the control machine 200, and the case of one-way transmission of data from the control machine 200 to the general-purpose application.

The information processing device 100 may include a camera. The general-purpose application in this case may cause an image captured by the camera to be displayed. The image analyzer 112 may acquire an image captured by the camera and analyze the captured image. The image analyzer 112 in this case may convert the image data into character data through character recognition. Alternatively, the camera may capture an image in a workroom, for example. The image analyzer 112 in this case may determine whether an operator is present in the workroom through image recognition of the captured image of the workroom, and provide the control machine 200 with data for turning on a subject to be controlled by the control machine 200 when the operator is present. Alternatively, the camera may capture an image of the display of a measuring instrument not coordinated with the control machine 200. The image analyzer 112 in this case may convert, through character recognition, the image that is displayed on the display and is included in the image captured by the camera into numerical data. This configuration allows the data measured by the measuring instrument not coordinated with the control machine 200 to be transmitted to the control machine 200.

Although the application controller 111 of the information processing device 100 executes a single general-purpose application in the above-described exemplary embodiment, the application controller 111 may execute multiple general-purpose applications and cause images of the general-purpose applications to be simultaneously displayed on the display 170. In an exemplary case where the information processing device 100 executes both of a first application and a second application, the image analyzer 112 of the information processing device 100 may read data from an image displayed by the first application and transmit the read data to the control machine 200, and input data transmitted from the control machine 200 into the second application. This configuration can achieve automation of user's manipulations of inputting data obtained from the image displayed by the first application into the control machine 200 and inputting the data obtained from the control machine 200 into the second application.

The operational unit 180 and the display 170 of the information processing device 100 constitute a touch panel display in the above-described exemplary embodiment. The operational unit 180 is only required to include a graphical user interface (GUI), and may receive manipulations with a mouse or touch pad. This modified configuration can also achieve ready coordination of the general-purpose application with the control machine 200, on the basis of a result of analysis of the image displayed on the display 170 by the general-purpose application.

Although the control system 1 controls an FA system in the above-described exemplary embodiment, the control system 1 is only required to control the control machine 200 on the basis of the image displayed on the display 170 of the information processing device 100. The control system 1 may be applied to control of any device or machine, such as elevator or platform door.

Although the controller 110 of the information processing device 100 includes a single processor 130 in the above-described exemplary embodiment, the functions may be achieved by cooperation of multiple processors 130. The controller 110 may include multiple main storages 140 and auxiliary storages 150. The above-described hardware configuration including the control machine 200 is a mere example and may be varied or revised into any modification.

The control system 1, the information processing device 100, and the control machine 200 can be achieved by not only dedicated systems but also ordinary computer systems. For example, a computer program for executing the above-described operations may be stored in non-transitory computer-readable recording mediums, such as flexible disks, compact disc read-only memories (CD-ROMs), and digital versatile disc read-only memories (DVD-ROMs), and distributed. The computer program may then be installed in a computer, so as to configure the control system 1 for executing the operations. Alternatively, the computer program may be stored in a storage device included in a server on a communication network, and may be downloaded into an ordinary computer system to configure the control system 1, the information processing device 100, and the control machine 200.

In the case where the functions of the control system 1, the information processing device 100, and the control machine 200 are achieved by sharing of an operating system (OS) and an application program or by cooperation of the OS and the application program, only the application program may be stored in a non-transitory recording medium or a storage device.

The computer program may be provided via a communication network in the form of being superimposed on a carrier wave. For example, the computer program may be posted on a bulletin board system (BBS) on a communication network and may be distributed to a computer via the communication network. The computer may activate this computer program and execute the computer program under the control of the OS in the same manner as the other application programs, and thereby execute the above-described operations.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Control system
100 Information processing device
110, 210 Controller
111 Application controller
112 Image analyzer
113, 211 Communication controller
120, 220 Communicator
130, 230 Processor
140, 240 Main storage
150, 250 Auxiliary storage
160, 260 Bus
170 Display
180 Operational unit
200 Control machine
300a Robot
300b Measuring instrument

1. An information processing device, comprising:
application controlling circuitry to execute an application that causes an image to be displayed on a display;
image analyzing circuitry to analyze the image displayed on the display by the application; and
communication controlling circuitry to
convert, based on a result of analysis of the image by the image analyzing circuitry, data obtained from the image displayed on the display by the application into data recognizable by a control machine, and
transmit the converted data to the control machine.

2. The information processing device according to claim 1, wherein the image analyzing circuitry
specifies a data entry area in a display area of the display on which the image is displayed by the application, and
inputs data transmitted from the control machine into the application in accordance with the specified data entry area.

3. The information processing device according to claim 1, wherein the image analyzing circuitry
sets a reading marker at a position in a display area of the display on which the image is displayed by the application, the reading marker indicating a position at which data is read, and
reads data displayed at the position at which the reading marker is set.

4. The information processing device according to claim 2, wherein the image analyzing circuitry
sets a writing marker in the display area of the display on which the image is displayed by the application, the writing marker indicating a position at which data is entered, and
inputs the data into the application in accordance with the position at which the writing marker is set, in response to transmission of the data from the control machine.

5. The information processing device according to claim 1, wherein the image analyzing circuitry analyzes the image displayed on the display by the application using any one or combination of artificial intelligence, machine learning, or pattern recognition.

6. The information processing device according to claim 1, wherein
the application causes an image captured by a camera to be displayed on the display, and
the image analyzing circuitry analyzes the image displayed on the display.

7. A control system, comprising:
the information processing device according to claim 1; and
the control machine to communicate with the information processing device.

8. An information processing method executed using an information processing device including an application that causes an image to be displayed on a display, the information processing method comprising:
analyzing the image displayed on the display by the application; and
converting, based on a result of analysis of the image, data obtained from the image displayed on the display by the application into data recognizable by a control machine, and transmitting the converted data to the control machine.

9. A non-transitory computer-readable recording medium storing a program for causing a computer including an application that causes an image to be displayed on a display, to function as:
an image analyzer to analyze the image displayed on the display by the application; and
a communication controller to
convert, based on a result of analysis of the image by the image analyzer, data obtained from the image displayed on the display by the application into data recognizable by a control machine, and
transmit the converted data to the control machine.

10. The information processing device according to claim 2, wherein the image analyzing circuitry
sets a reading marker at a position in the display area of the display on which the image is displayed by the application, the reading marker indicating a position at which data is read, and
reads data displayed at the position at which the reading marker is set.

11. The information processing device according to claim 2, wherein the image analyzing circuitry analyzes the image displayed on the display by the application using any one or combination of artificial intelligence, machine learning, or pattern recognition.

12. The information processing device according to claim 3, wherein the image analyzing circuitry analyzes the image displayed on the display by the application using any one or combination of artificial intelligence, machine learning, or pattern recognition.

13. The information processing device according to claim 4, wherein the image analyzing circuitry analyzes the image displayed on the display by the application using any one or combination of artificial intelligence, machine learning, or pattern recognition.

14. The information processing device according to claim 2, wherein
the application causes an image captured by a camera to be displayed on the display, and
the image analyzing circuitry analyzes the image displayed on the display.

15. The information processing device according to claim 3, wherein
the application causes an image captured by a camera to be displayed on the display, and
the image analyzing circuitry analyzes the image displayed on the display.

16. The information processing device according to claim 4, wherein
the application causes an image captured by a camera to be displayed on the display, and
the image analyzing circuitry analyzes the image displayed on the display.

17. The information processing device according to claim 5, wherein
the application causes an image captured by a camera to be displayed on the display, and
the image analyzing circuitry analyzes the image displayed on the display.

18. A control system, comprising:
the information processing device according to claim 2; and
the control machine to communicate with the information processing device.

19. A control system, comprising:
the information processing device according to claim 3; and
the control machine to communicate with the information processing device.

20. A control system, comprising:
the information processing device according to claim 4; and
the control machine to communicate with the information processing device.
